(19) United States
(12) Patent Application Publication
(10) Pub. No.: US 2021/0340938 A1
(43) Pub. Date: Nov. 4, 2021

(54) FUEL OXYGEN REDUCTION UNIT

(71) Applicant: General Electric Company, Schenectady, NY (US)

(72) Inventors: Brandon Wayne Miller, Liberty Township, OH (US); Robert Jon McQuiston, Cincinnati, OH (US); David Justin Brady, Rockport, MA (US)

(21) Appl. No.: 16/864,632

(22) Filed: May 1, 2020

(51) Int. Cl. F02M 33/02; F02C 3/00

(52) U.S. Cl. CPC F02M 33/02; F05D 2270/07; F05D 2220/323; F02C 3/00

(57) ABSTRACT

An engine system is provided for an aircraft having an engine and an engine controller. The engine system includes: an electric machine configured to be in electrical communication with the engine controller for powering the engine controller; and a fuel oxygen reduction unit defining a liquid fuel flowpath and a stripping gas flowpath and configured to transfer an oxygen content of a fuel flow through the liquid fuel flowpath to a stripping gas flow through the stripping gas flowpath, the fuel oxygen reduction unit also in electrical communication with the electric machine such that the electric machine powers at least in part the fuel oxygen reduction unit.

### FIELD OF THE INVENTION

The present subject matter relates generally to a fuel oxygen reduction unit for an engine and a method of operating the same.

### BACKGROUND OF THE INVENTION

Typical aircraft propulsion systems include one or more gas turbine engines. The gas turbine engines generally include a turbomachine, the turbomachine including, in serial flow order, a compressor section, a combustion section, a turbine section, and an exhaust section. In operation, air is provided to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

Certain operations and systems of the gas turbine engines and aircraft may generate a relatively large amount of heat. Fuel has been determined to be an efficient heat sink to receive at least some of such heat during operations due at least in part to its heat capacity and an increased efficiency in combustion operations that may result from combusting higher temperature fuel.

However, heating the fuel up without properly conditioning the fuel may cause the fuel to “coke,” or form solid particles that may clog up certain components of the fuel system, such as the fuel nozzles. Reducing an amount of oxygen in the fuel may effectively reduce the likelihood that the fuel will coke beyond an unacceptable amount.

### BRIEF DESCRIPTION OF THE INVENTION

Aspects and advantages of the invention will be set forth in part in the following description, or may be obvious from the description, or may be learned through practice of the invention.

In one exemplary embodiment of the present disclosure, an engine system is provided for an aircraft having an engine and an engine controller. The engine system includes: an electric machine configured to be in electrical communication with the engine controller for powering the engine controller; and a fuel oxygen reduction unit defining a liquid fuel flowpath and a stripping gas flowpath and configured to transfer an oxygen content of a fuel flow through the liquid fuel flowpath to a stripping gas flow through the stripping gas flowpath, the fuel oxygen reduction unit also in electrical communication with the electric machine such that the electric machine powers at least in part the fuel oxygen reduction unit.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic, cross-sectional view of a gas turbine engine in accordance with an exemplary embodiment of the present disclosure.

FIG. 2 is a schematic view of a fuel oxygen reduction unit in accordance with an exemplary embodiment of the present disclosure.

FIG. 3 is a schematic view of an engine system in accordance with an exemplary embodiment of the present disclosure.

FIG. 4 is a flow diagram of a method for operating an engine system for an aircraft in accordance with an exemplary aspect of the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

In a conventional setup, a full authority digital control (FADEC) engine controller is powered by a dedicated permanent magnet alternator (PMA), which is in turn rotated by/driven by an accessory gearbox (AGB) of a gas turbine engine. The PMA is therefore sized to be capable of providing a sufficient amount of electrical power to the FADEC during substantially all operating conditions, including relatively low-speed operating conditions, such as start-up and idle. As the engine comes up to speed, however, the PMA may generate an increased amount electric power, while an amount of electric power required to operate the FADEC may remain relatively constant. Accordingly, as the engine comes up to speed the PMA may generate an amount of excess electric power that may need to be dissipated through an electrical sink.

The inventors of the present disclosure have found that a power consumption need for a fuel oxygen reduction unit may complement the power generation of the PMA. More specifically, the fuel oxygen reduction unit may need a relatively low amount of electric power during low rotational speeds of the gas turbine engine (when the PMA is not creating much excess electrical power), and a relatively high amount of electric power during high rotational speeds of the gas turbine engine (when the PMA is creating excess electrical power). Accordingly, by using the PMA to power the fuel oxygen reduction unit, the electrical power generated by the PMA may be more efficiently utilized.

It will be appreciated, however, that such a configuration is by way of example only, and in other embodiments the FADEC may be any other suitable engine controller, the PMA may be any other suitable electric machine, etc. Accordingly, in certain embodiments, an engine system is provided for an aircraft having an engine and an engine controller. The engine system includes an electric machine configured to be in electrical communication with the engine controller for powering the engine controller; and a fuel oxygen reduction unit defining a liquid fuel flowpath and a stripping gas flowpath and configured to transfer an oxygen content of a fuel flow through the liquid fuel flowpath to a stripping gas flow through the stripping gas flowpath, the fuel oxygen reduction unit also in electrical communication with the electric machine such that the electric machine powers at least in part the fuel oxygen reduction unit.

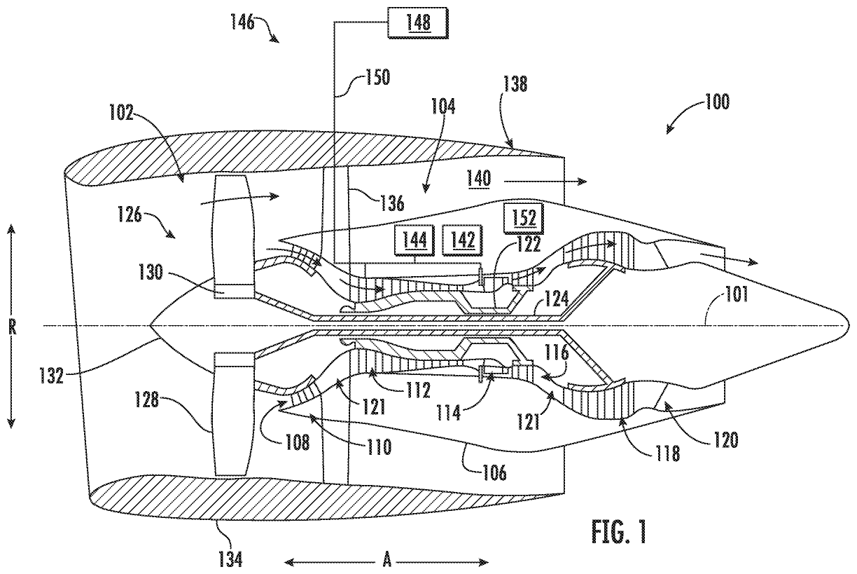

Referring now to the drawings, wherein identical numerals indicate the same elements throughout the figures, FIG. 1 provides a schematic, cross-sectional view of an engine in accordance with an exemplary embodiment of the present disclosure. The engine may be incorporated into a vehicle. For example, the engine may be an aeronautical engine incorporated into an aircraft. Alternatively, however, the engine may be any other suitable type of engine for any other suitable aircraft.

For the embodiment depicted, the engine is configured as a high bypass turbofan engine 100. As shown in FIG. 1, the turbofan engine 100 defines an axial direction A (extending parallel to a longitudinal centerline or axis 101 provided for reference), a radial direction R, and a circumferential direction (extending about the axial direction A; not depicted in FIG. 1). In general, the turbofan 100 includes a fan section 102 and a turbomachine 104 disposed downstream from the fan section 102.

The exemplary turbomachine 104 depicted generally includes a substantially tubular outer casing 106 that defines an annular inlet 108. The outer casing 106 encases, in serial flow relationship, a compressor section including a booster or low pressure (LP) compressor 110 and a high pressure (HP) compressor 112; a combustion section 114; a turbine section including a high pressure (HP) turbine 116 and a low pressure (LP) turbine 118; and a jet exhaust nozzle section 120. The compressor section, combustion section 114, and turbine section together define at least in part a core air flowpath 121 extending from the annular inlet 108 to the jet nozzle exhaust section 120. The turbofan engine further includes one or more drive shafts. More specifically, the turbofan engine includes a high pressure (HP) shaft or spool 122 drivingly connecting the HP turbine 116 to the HP compressor 112, and a low pressure (LP) shaft or spool 124 drivingly connecting the LP turbine 118 to the LP compressor 110.

For the embodiment depicted, the fan section 102 includes a fan 126 having a plurality of fan blades 128 coupled to a disk 130 in a spaced apart manner. The fan blades 128 and disk 130 are together rotatable about the longitudinal axis 101 by the LP shaft 124. The disk 130 is covered by rotatable front hub 132 aerodynamically contoured to promote an airflow through the plurality of fan blades 128. Further, an annular fan casing or outer nacelle 134 is provided, circumferentially surrounding the fan 126 and/or at least a portion of the turbomachine 104. The nacelle 134 is supported relative to the turbomachine 104 by a plurality of circumferentially-spaced outlet guide vanes 136. A downstream section 138 of the nacelle 134 extends over an outer portion of the turbomachine 104 so as to define a bypass airflow passage 140 therebetween.

Referring still to FIG. 1, the turbofan engine 100 additionally includes an accessory gearbox 142, a fuel oxygen reduction unit 144, and a fuel delivery system 146. For the embodiment shown, the accessory gearbox 142 is located within the cowling/outer casing 106 of the turbomachine 104. Additionally, it will be appreciated that, although not depicted schematically in FIG. 1, the accessory gearbox 142 may be mechanically coupled to, and rotatable with, one or more shafts or spools of the turbomachine 104. For example, in at least certain exemplary embodiments, the accessory gearbox 142 may be mechanically coupled to, and rotatable with, the HP shaft 122. Notably, as used herein, the term “fuel oxygen conversion” generally means a device capable of reducing a free oxygen content of the fuel.

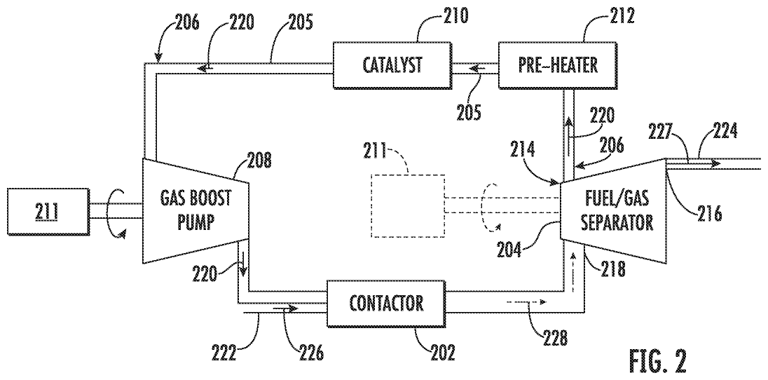

Moreover, the fuel delivery system 146 generally includes a fuel source 148, such as a fuel tank, and one or more fuel lines 150. The one or more fuel lines 150 provide a fuel flow through the fuel delivery system 146 to the combustion section 114 of the turbomachine 104 of the turbofan engine 100. A more detailed schematic of a fuel delivery system in accordance with an exemplary embodiment of the present disclosure is provided below with reference to FIG. 2.

As will also be described in more detail below with reference to FIG. 2, the exemplary turbofan engine includes an engine controller. More specifically, the engine controller is a full authority digital engine control engine controller, also known as a FADEC 152. The FADEC 152 is a computer-managed aircraft ignition and engine control system used in aircraft to control all or many aspects of engine performance. The FADEC 152 may receive electric power from an electric generator (not shown). The electric generator may be driven by the accessory gearbox 142, and as will be described below, may also provide electric power to the fuel oxygen reduction unit 144.

It will be appreciated, however, that the exemplary turbofan engine 100 depicted in FIG. 1 is provided by way of example only. In other exemplary embodiments, any other suitable engine may be utilized with aspects of the present disclosure. For example, in other embodiments, the engine may be any other suitable gas turbine engine, such as a turboshaft engine, turboprop engine, turbojet engine, etc. In such a manner, it will further be appreciated that in other embodiments the gas turbine engine may have any other suitable configuration, such as any other suitable number or arrangement of shafts, compressors, turbines, fans, etc. Further, although the exemplary gas turbine engine depicted in FIG. 1 is shown schematically as a direct drive, fixed-pitch turbofan engine 100, in other embodiments, a gas turbine engine of the present disclosure may be a geared gas turbine engine (i.e., including a gearbox between the fan 126 and shaft driving the fan, such as the LP shaft 124), may be a variable pitch gas turbine engine (i.e., including a fan 126 having a plurality of fan blades 128 rotatable about their respective pitch axes), etc. Further, although not depicted herein, in other embodiments the gas turbine engine may be any other suitable type of gas turbine engine, such as an industrial gas turbine engine incorporated into a power generation system, a nautical gas turbine engine, etc. Further, still, in alternative embodiments, aspects of the present disclosure may be incorporated into, or otherwise utilized with, any other type of engine, such as reciprocating engines.

Moreover, it will be appreciated that although for the embodiment depicted, the turbofan engine 100 includes the fuel oxygen reduction unit 144 positioned within the turbomachine 104, i.e., within the casing 106 of the turbomachine 104, in other embodiments, the fuel oxygen reduction unit 144 may be positioned at any other suitable location. For example, in other embodiments, the fuel oxygen reduction unit 144 may instead be positioned remote from the turbofan engine 100.

Referring now to FIGS. 2 and 5, a schematic drawing of a fuel oxygen reduction unit or oxygen transfer assembly 200 for a gas turbine engine in accordance with an exemplary aspect of the present disclosure is provided. In at least certain exemplary embodiments, the exemplary fuel oxygen reduction unit 200 depicted may be incorporated into, e.g., the exemplary engine 100 described above with reference to FIG. 1 (e.g., may be the fuel oxygen reduction unit 144 depicted in FIG. 1 and described above).

As will be appreciated from the discussion herein, in an exemplary embodiment, the fuel oxygen reduction unit 200 generally includes a contactor 202, a separator 204, a boost pump 208, and a turbine 211 that is coupled to the boost pump 208. In one exemplary embodiment, the separator 204 may be a dual separator pump. In other exemplary embodiments, other separators may be utilized with the fuel oxygen reduction unit 200 of the present disclosure. Further, in other exemplary embodiments, the fuel oxygen reduction unit 200 may additionally or alternatively include a membrane assembly meant to filter or suck out an amount of oxygen from a fuel flow into a stripping gas flow, or chemically react with an oxygen in the fuel to reduce the oxygen in the fuel. In such embodiments, the oxygen transfer assembly 200 may not include a contactor and a separator.

Referring still particularly to the embodiment of FIG. 2, in the exemplary fuel oxygen reduction unit 200 depicted, the boost pump 208 is disposed downstream of the separator 204 and upstream of the contactor 202. The boost pump 208 circulates a stripping gas 220 to the contactor 202. Further, the boost pump 208 is coupled to, and driven by, a power source 211, as will be described below.

Referring still to FIG. 2, the exemplary contactor 202 depicted may be configured in any suitable manner to substantially mix a received gas and liquid flow. For example, the contactor 202 may, in certain embodiments be a mechanically driven contactor (e.g., having paddles for mixing the received flows), or alternatively may be a passive contactor for mixing the received flows using, at least in part, a pressure and/or flowrate of the received flows. For example, a passive contactor may include one or more turbulators, a venturi mixer, etc.

Moreover, the exemplary fuel oxygen reduction unit 200 includes a stripping gas line 205, and more particularly, includes a plurality of stripping gas lines 205, which together at least in part define a circulation gas flowpath 206 extending from the separator 204 to the contactor 202. In certain exemplary embodiments, the circulation gas flowpath 206 may be formed of any combination of one or more conduits, tubes, pipes, etc. in addition to the plurality stripping gas lines 205 and structures or components within the circulation gas flowpath 206.

As will be explained in greater detail, below, the fuel oxygen reduction unit 200 generally provides for a flow of stripping gas 220 through the plurality of stripping gas lines 205 and stripping gas flowpath 206 during operation. It will be appreciated that the term “stripping gas” is used herein as a term of convenience to refer to a gas generally capable of performing the functions described herein. The stripping gas 220 flowing through the stripping gas flowpath/circulation gas flowpath 206 may be an actual stripping gas functioning to strip oxygen from the fuel within the contactor, or alternatively may be a sparging gas bubbled through a liquid fuel to reduce an oxygen content of such fuel. For example, as will be discussed in greater detail below, the stripping gas 220 may be an inert gas, such as Nitrogen or Carbon Dioxide (CO2), a gas mixture made up of at least 50% by mass inert gas, or some other gas or gas mixture having a relatively low oxygen content.

Moreover, as noted above, for the exemplary fuel oxygen reduction unit 200 depicted, the fuel oxygen reduction unit 200 further includes the boost pump 208, a catalyst 210, and a pre-heater 212. The boost pump 208, the catalyst 210, and the pre-heater 212 may be arranged in different configurations within, or otherwise in airflow communication with, the circulation gas flowpath 206.

Referring to FIG. 2, in an exemplary embodiment, the arrangement includes the pre-heater 212, the catalyst 210, and the boost pump 208 in a series flow. Thus, a flow of the stripping gas 220 exits a stripping gas outlet 214 of the separator 204 and then flows through the pre-heater 212, the catalyst 210, and the boost pump 208 in a series flow. Next, the resulting relatively low oxygen content stripping gas is provided through the remainder of the circulation gas flowpath 206 and back to the contactor 202, such that the cycle may be repeated.

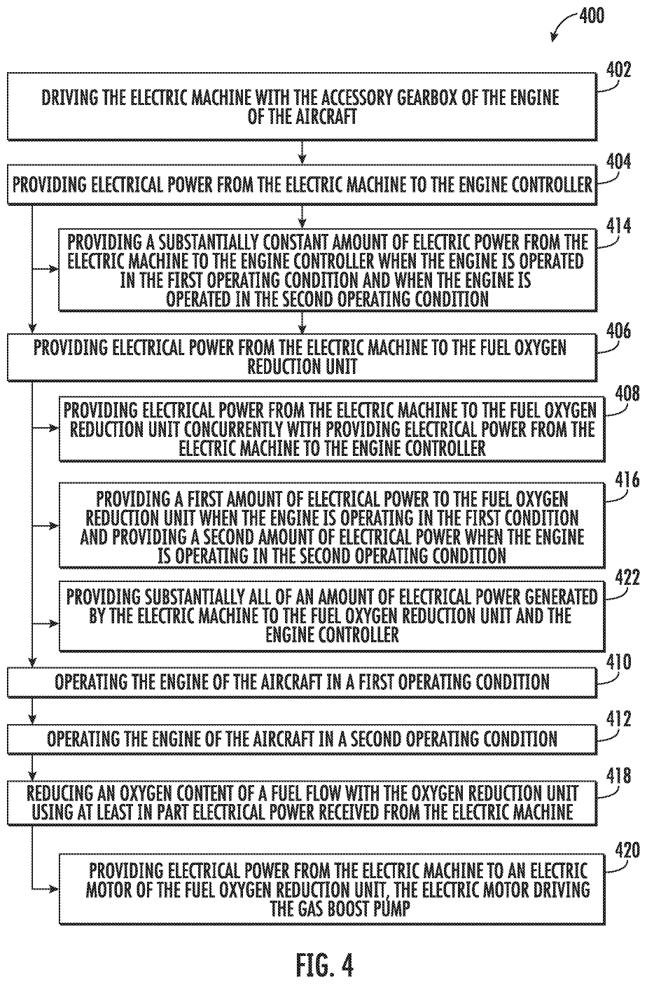

Referring to FIG. 4, in another exemplary embodiment, the arrangement includes the boost pump 208, the pre-heater 212, and the catalyst 210 in a series flow. Thus, a flow of the stripping gas 220 exits a stripping gas outlet 214 of the separator 204 and then flows through the boost pump 208, the pre-heater 212, and the catalyst 210 in a series flow. Next, the resulting relatively low oxygen content stripping gas is then provided through the remainder of the circulation gas flowpath 206 and back to the contactor 202, such that the cycle may be repeated.

In other exemplary embodiments, the arrangement of the components of the fuel oxygen reduction unit 200 may be arranged in different configurations within the circulation gas flowpath 206.

In an exemplary embodiment, the boost pump 208 is configured to increase a pressure of the stripping gas 220 flowing through the circulation gas flowpath 206 and to, for the embodiment shown, the contactor 202. The gas boost pump 208 may be configured as a rotary gas pump, a reciprocating pump, a piston pump, a gear pump, a screw pump, or any other device suitable for increasing a pressure and/or flowrate of the stripping gas 220 flowing through the circulation gas flowpath 206.

Referring still to FIG. 2, in an exemplary embodiment, the separator 204 generally includes the stripping gas outlet 214, a fuel outlet 216, and an inlet 218. It will also be appreciated that the exemplary fuel oxygen reduction unit 200 depicted is operable with a fuel delivery system, such as a fuel delivery system 146 of the gas turbine engine including the fuel oxygen reduction unit 144 (see, e.g., FIG. 1). The exemplary fuel delivery system generally includes a plurality of fuel lines, and in particular, an inlet fuel line 222 and an outlet fuel line 224. The inlet fuel line 222 is fluidly connected to the contactor 202 for providing a flow of liquid fuel or inlet fuel flow 226 to the contactor 202 (e.g., from a fuel source, such as a fuel tank) and the outlet fuel line 224 is fluidly connected to the fuel outlet 216 of the separator 204 for receiving a flow of deoxygenated liquid fuel or outlet fuel flow 227.

Moreover, during typical operations, a flow of stripping gas 220 flows through the circulation gas flowpath 206 from the stripping gas outlet 214 of the separator 204 to the contactor 202. More specifically, during typical operations, stripping gas 220 flows from the stripping gas outlet 214 of the separator 204, through the pre-heater 212 (configured to add heat energy to the gas flowing therethrough), through the catalyst 210, and to/through the boost pump 208, wherein a pressure of the stripping gas 220 is increased to provide for the flow of the stripping gas 220 through the circulation gas flowpath 206. The relatively high pressure stripping gas 220 (i.e., relative to a pressure upstream of the boost pump 208 and the fuel entering the contactor 202) is then provided to the contactor 202, wherein the stripping gas 220 is mixed with the flow of inlet fuel 226 from the inlet fuel line 222 to generate a fuel gas mixture 228. The fuel gas mixture 228 generated within the contactor 202 is provided to the inlet 218 of the separator 204.

Referring to FIG. 2, in an exemplary embodiment, the catalyst 210 is disposed downstream of the separator 204. The catalyst 210 receives and treats the outlet stripping gas flow that flows out of the separator 204 to reduce the oxygen content of the outlet stripping gas flow. In this manner, an inlet stripping gas flow exits the catalyst and flows to the contactor 202. This inlet stripping gas flow that's flows to the contactor 202 has a lower oxygen content than the outlet stripping gas flow that flows out of the separator 204. Referring to FIG. 2, in an exemplary embodiment, the boost pump 208 is disposed between the catalyst 210 and the contactor 202.

Generally, it will be appreciated that during operation of the fuel oxygen reduction unit 200, the inlet fuel 226 provided through the inlet fuel line 222 to the contactor 202 may have a relatively high oxygen content. The stripping gas 220 provided to the contactor 202 may have a relatively low oxygen content or other specific chemical structure. Within the contactor 202, the inlet fuel 226 is mixed with the stripping gas 220, resulting in the fuel gas mixture 228. As a result of such mixing a physical exchange may occur whereby at least a portion of the oxygen within the inlet fuel 226 is transferred to the stripping gas 220, such that the fuel component of the mixture 228 has a relatively low oxygen content (as compared to the inlet fuel 226 provided through inlet fuel line 222) and the stripping gas component of the mixture 228 has a relatively high oxygen content (as compared to the inlet stripping gas 220 provided through the circulation gas flowpath 206 to the contactor 202).

Within the separator 204 the relatively high oxygen content stripping gas 220 is then separated from the relatively low oxygen content fuel 226 back into respective flows of an outlet stripping gas 220 and outlet fuel 227.

It will be appreciated that the outlet fuel 227 provided to the fuel outlet 216, having interacted with the stripping gas 220, may have a relatively low oxygen content, such that a relatively high amount of heat may be added thereto with a reduced risk of the fuel coking (i.e., chemically reacting to form solid particles which may clog up or otherwise damage components within the fuel flow path). For example, in at least certain exemplary aspects, the outlet fuel 227 provided to the fuel outlet 216 may have an oxygen content of less than about twenty (20) parts per million (“ppm”), such as less than about fifteen (15) ppm, such as less than about ten (10) ppm, such as less than about five (5) ppm.

Moreover, as will be appreciated, the exemplary fuel oxygen reduction unit 200 depicted recirculates and reuses the stripping gas 220 (i.e., the stripping gas 220 operates in a substantially closed loop). However, the stripping gas 220 exiting the separator 204, having interacted with the liquid fuel 226, has a relatively high oxygen content. Accordingly, in order to reuse the stripping gas 220, an oxygen content of the stripping gas 220 from the outlet 214 of the separator 204 needs to be reduced. For the embodiment depicted, and as noted above, the stripping gas 220 flows through the pre-heater 212, through the catalyst 210 where the oxygen content of the stripping gas 220 is reduced, and through the boost pump 208 where a pressure of the stripping gas 220 is increased to provide for the flow of the stripping gas 220 through the circulation gas flowpath 206.

More specifically, within the catalyst 210 the relatively oxygen-rich stripping gas 220 is reacted to reduce the oxygen content thereof. It will be appreciated that catalyst 210 may be configured in any suitable manner to perform such functions. For example, in certain embodiments, the catalyst 210 may be configured to combust the relatively oxygen-rich stripping gas 220 to reduce an oxygen content thereof. However, in other embodiments, the catalyst 210 may additionally, or alternatively, include geometries of catalytic components through which the relatively oxygen-rich stripping gas 220 flows to reduce an oxygen content thereof. In one or more of these embodiments, the catalyst 210 may be configured to reduce an oxygen content of the stripping gas 220 to less than about five percent (5%) oxygen (O2) by mass, such less than about two (2) percent (3%) oxygen (O2) by mass, such less than about one percent (1%) oxygen (O2) by mass.

The resulting relatively low oxygen content gas is then provided through the remainder of the circulation gas flowpath 206 and back to the contactor 202, such that the cycle may be repeated. In such a manner, it will be appreciated that the stripping gas 220 may be any suitable gas capable of undergoing the chemical transitions described above. For example, the stripping gas may be air from, e.g., a core air flowpath of a gas turbine engine including the fuel oxygen reduction unit 200 (e.g., compressed air bled from an HP compressor 112; see FIG. 1).

However, in other embodiments, the stripping gas may instead be any other suitable gas, such as an inert gas, such as Nitrogen or Carbon Dioxide (CO2), a gas mixture made up of at least 50% by mass inert gas, or some other gas or gas mixture having a relatively low oxygen content.

It will be appreciated, however, that the exemplary fuel oxygen reduction unit 200 described above is provided by way of example only. In other embodiments, the fuel oxygen reduction unit 200 may be configured in any other suitable manner.

In other embodiments, the stripping gas 220 may not flow through a circulation gas flowpath 206, and instead the fuel oxygen reduction unit 200 may include an open loop stripping gas flowpath, with such flowpath in flow communication with a suitable stripping gas source, such as a bleed air source, and configured to dump such air to the atmosphere downstream of the fuel gas separator 204.

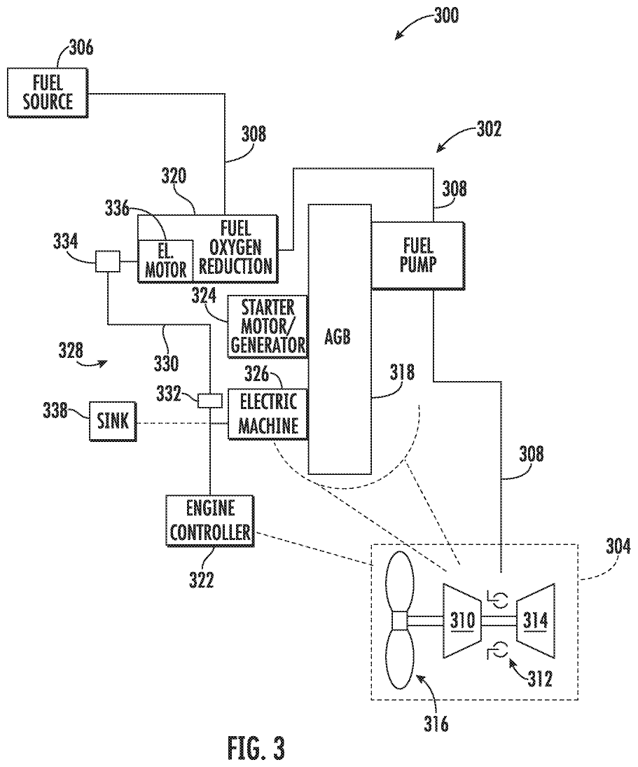

Referring to FIG. 3, an exemplary engine system 300 of an aircraft is provided. The exemplary engine system 300 generally includes a fuel delivery system 302 and aeronautical engine 304, which may be configured in a manner similar to the exemplary fuel delivery system 146 and turbofan engine 100 of FIG. 1. Accordingly, it will be appreciated that the exemplary fuel delivery system 302 of FIG. 3 may generally include a fuel source 306 and a plurality of fuel lines 308.

As is depicted schematically in FIG. 3, the engine 304 may be a gas turbine engine generally including a compressor section 310, a combustion section 312, and a turbine section 314 in serial flow order, with one or more of such components drivingly coupled to a propulsor 316, which for the embodiment shown is a fan.

Also similar to the exemplary embodiment of FIG. 1, the exemplary engine 304 further includes an accessory gearbox 318, a fuel oxygen reduction unit 320, and an engine controller 322. The accessory gearbox 318 is drivingly coupled to a rotating component of the engine 304, such as a shaft or spool of the engine 304. As is depicted using the phantom lines, in certain exemplary aspects, the accessory gearbox 318 may be included within a cowling or casing of the engine 304 (see, e.g., FIG. 1). Alternatively, however, the accessory gearbox 318 may be positioned at any other suitable location.

In such a manner, a rotation of the engine 304 may correspondingly rotate the accessory gearbox 318. Such rotation of the accessory gearbox 318 may allow the accessory gearbox 318 to power various accessory systems of the engine 304, such as, for example, various fluid pumps, thermal management systems, electric generators, etc., and further may allow for the accessory gearbox 318 to add power to the engine 304 through, for example, one or more electric motors. For example, in certain exemplary embodiment, such as the exemplary embodiment depicted, the accessory gearbox 318 may be coupled to a starter motor/generator 324 for, e.g., assisting with starting the engine 304, as well as for, e.g., extracting power from the engine 304 to power certain electronic devices of the engine 304 and/or aircraft.

Further, for the embodiment shown, the fuel delivery system 302 includes an electric machine 326 configured to be in electrical communication with the engine controller 322 for powering the engine controller 322. As is depicted in FIG. 3, the electric machine 326 is coupled to the accessory gearbox 318, such that the electric machine 326 is configured to be rotated by the accessory gearbox 318.

In certain exemplary embodiments, the electric machine 326 may be a permanent magnet alternator (“PMA”) configured to power the engine controller 322. Although not shown, the PMA may include a rotor rotatable with the accessory gearbox 318 and a stater that is stationary relative to the rotor. The rotor may include a plurality of permanent magnets, and a relative rotation between the rotor in the stator may allow the PMA to generate an alternating current electrical power.

Alternatively, however, in other embodiments, the electric machine 326 instead be configured in any other suitable manner. For example, in other embodiments, the electric machine 326 may be configured to generate a direct-current electrical power.

As described with reference to the figures above, in certain exemplary embodiments, the engine controller 322 may be a full authority digital engine control engine controller, also referred to as a FADEC. In such a manner, it will be appreciated that the engine controller 322 is operably coupled to the engine 304 for controlling a variety of different aspects of the engine 304, for sensing various operating parameters/conditions of the engine 304, receiving control inputs for the engine 304, etc. Further, in such manner, it will be appreciated that the electric machine 326 may be designed to provide a sufficient amount of electrical power to the engine controller 322 throughout substantially all operating conditions/speeds of the engine 304, as will be explained in more detail below.

Notably, for the embodiment shown, the electric machine 326 is not dedicated to the engine controller 322, and instead is configured to further provide electrical power to the fuel oxygen reduction unit 320 to power at least in part the fuel oxygen reduction unit 320. For example, it will be appreciated that typically, the electric machine 326 powering the engine controller 322 is sized to provide a sufficient amount of electric power to support operation of the engine controller 322 at all, or substantially all, operating conditions of the engine 304. Accordingly, for example, the electric machine 326 must be sized sufficiently large enough to provide a sufficient electrical power to support operation of the engine controller 322 when the engine 304 is operating at a relatively low rotational speed, such as during start-up, ignition, and/or idle. As noted above, the electrical machine 326 is rotatable with accessory gearbox 318, which is in turn rotatable with the engine 304, such that during operating conditions of the engine having relatively low rotational speeds, the electric machine 326 is configured to generate a relatively low amount of electrical power.

As such, it being appreciated that the amount of electric power required to operate the engine controller 322 may not significantly change between operating conditions, as the engine 304 transitions into higher rotational speed operating conditions, the electric machine 326 may generate an amount of electric power as the engine 304 in excess of that needed solely by the engine controller 322. Instead of such excess electrical power being wasted, for the embodiment shown, the fuel oxygen reduction unit 320 is also in electrical communication with the electric machine 326 such that the electric machine 326 powers at least in part the fuel oxygen reduction unit 320. By contrast to the engine controller 322, the fuel oxygen reduction unit 320 may require an increased amount of electrical power when the engine 304 is operating at higher operating speeds as compared to when the engine 304 is operating at relatively low rotational speeds. Accordingly, the electrical power generated by the electric machine 326 across various engine operating conditions/speeds may be more efficiently utilized by the engine system 300 depicted. More specifically, by slightly increasing a size of the electric machine 326 to accommodate both the engine controller 322 and the fuel oxygen reduction unit 320 at the lower operating speeds of the engine 304 (where the fuel oxygen reduction unit 320 does not require much energy), a much larger percentage of an amount of electrical power generated by the electric machine 326 at increased rotational speeds of the engine 304 may be more effectively utilized.

More specifically, for the embodiment shown, the fuel delivery system 302 further includes a power bus 328 having an electric line 330 and a power electronics assembly positioned along the electric line 330 electrically between the electric machine 326 and the fuel oxygen reduction unit 320. The exemplary power electronics assembly includes an inverter 332, a rectifier 334, or both. More specifically, for the embodiment depicted, the power electronics assembly includes a rectifier 334 located proximate electric machine 326 and an inverter 332 located proximate the fuel oxygen reduction unit 320. In such a manner, the electric machine 326 may be configured to generate alternating current electrical power. The alternating current electric power generated may be converted to a direct-current electrical power by the rectifier 334 and transferred along the electric line 330 of the the power bus 328 to the inverter 332, where such direct-current electrical power may be converted back to an alternating current electrical power to be utilized by the fuel oxygen reduction unit 320.

Specifically, for the embodiment shown, the fuel oxygen reduction unit 320 includes an electric motor 336 electrically coupled to the power bus 328 for receiving electrical power from the power bus 328. Referring back briefly to FIG. 2, when configured in such a manner, the electric motor 336 may be the power source 211 drivingly coupled to the gas boost pump 208 for powering the gas boost pump 208. In such manner, the gas boost pump 208 may be powered at least in part by the electric machine 326. Additionally, as is depicted in phantom, the fuel oxygen reduction unit 320 may further include a separate electric motor 336/power source 211 drivingly coupled to the fuel/gas separator 204 for powering the fuel/gas separator 204. In such a manner, the fuel oxygen reduction unit 320 may include multiple electric motors 336/power sources 211 configured to receive electrical power from the electric machine 326 driven off of the accessory gearbox 318. Additionally, or alternatively, the fuel oxygen reduction unit 320 may only include one of such electric machines 326/power sources 211, and the fuel oxygen reduction unit 320 may include another power source (not shown) for driving the other of the gas boost pump 208 or the fuel/gas separator 204, if such components are included.

Additionally, or alternatively, still, the fuel oxygen reduction unit 320 may only include one of such electric machines 326/power sources 211, and the gas boost pump 208 and the fuel/gas separator 204 may be mechanically linked, such that the gas boost pump 208 and the fuel/gas separator 204 are configured to rotate with one another. Additionally, or alternatively, still, the fuel oxygen reduction unit 320 may utilize electric power provided through the power bus 328 from the electric machine 326 in any other suitable manner, such as through use of an electric resistance heater (as, e.g., the preheater 212 in FIG. 2), through use of a powered contactor (as contactor 202 in FIG. 2), etc.

Referring back to FIG. 3, the exemplary fuel delivery system 302 may optionally further include an electrical sink 338 in electrical communication with the electric machine 326 to receive any electrical power generated by the electric machine 326 in excess of an amount of electrical power required by the engine controller 322 and the fuel oxygen reduction unit 320. As will be appreciated, the electric machine 326 is mechanically linked to the accessory gearbox 318, such that the electric machine 326 is configured to rotate with the accessory gearbox 318 and the rotating components of the engine 304 driving the accessory gearbox 318. In such a manner, the electric machine 326 may generate excess electrical power during certain operating conditions of the electric machine 326, and based on, e.g., certain ambient or other operating conditions of the engine 304 and/or aircraft including the engine 304. The electrical sink 338 may simply be a series of electrical resistors, or any other suitable configuration configured to receive excess electrical power and convert such electrical power to, e.g., heat energy. In some embodiments, this excess electrical energy converted to heat energy may be used to perform a de-icing function, such as to mitigate the accumulation of ice at an inlet, splitter or output guide vane. In those embodiments the series of electrical resistors may be placed in thermal contact with an external surface of a nacelle, fairing or other external surface that can experience ice accumulation.

In such manner, it will be appreciated that the electric machine 326 may be configured to provide substantially all of the electrical power generated during operation of the engine 304 to the engine controller 322 and the fuel oxygen reduction unit 320. Additionally, or alternatively, if the electrical sink 338 is included, the electric machine 326 may be configured to provide substantially all of the electrical power generated during operation of the engine 304 to the engine controller 322, the fuel oxygen reduction unit 320, and the electrical sink 338.

Referring still to FIG. 3, the fuel delivery system 302 further includes a fuel pump 340 also driven off the accessory gearbox 318 for receiving the deoxygenated fuel from the fuel oxygen reduction unit 320 and providing such fuel to the combustion section 312 of the engine 304. Although not depicted, the fuel delivery system 302 may include a variety of, e.g., fuel metering valves, distribution valves, bypass valves, distribution lines, manifolds, etc.

Notably, the system of the present disclosure allows for the fuel oxygen reduction unit 320, including, e.g., the boost pump 208 to be powered without being mechanically linked to the accessory gearbox 318 of the engine 304. In this manner, the system of the present disclosure allows for control of a stripping gas flow rate within the fuel oxygen reduction unit 320 independently of a speed of rotation of the engine 304. This system may therefore allow for the boost pump 208 to be controlled and set at an optimum speed for the fuel oxygen reduction unit 320 for a given cycle point of the engine 304.

Referring now to FIG. 4, a flow diagram of a method 400 for operating an engine system of an aircraft is provided. In certain exemplary aspects, the engine system may include certain aspects of the fuel delivery systems and engines described above with reference to FIGS. 1 through 3. Accordingly, the exemplary engine system may generally include a fuel delivery system having a fuel oxygen reduction unit; an accessory gearbox; an electric machine coupled to, and driven by, the accessory gearbox; and an engine controller operably coupled to an engine of the aircraft.

For the exemplary aspect depicted, the method 400 includes at (402) driving the electric machine with the accessory gearbox of the engine of the aircraft. Driving the electric machine at (402) may include rotating the electric machine with the accessory gearbox through a mechanical linkage. In certain exemplary aspects, a connection with the accessory gearbox may be referred to as a pad.

The method 400 further includes at (404) providing electrical power from the electric machine to the engine controller, and at (406) providing electrical power from the electric machine to the fuel oxygen reduction unit. Notably, for the exemplary aspect depicted, providing electrical power from the electric machine to the fuel oxygen reduction unit at (406) includes at (408) providing electrical power from the electric machine to the fuel oxygen reduction unit concurrently with providing electrical power from the electric machine to the engine controller at (404).

Referring still to be exemplary aspect of FIG. 4, the method 400 further includes at (410) operating the engine of the aircraft in a first operating condition, and at (412) operating the engine of the aircraft in a second operating condition. The first operating condition may be a relatively low-power operating condition and the second operating condition may be a relatively high-power operating condition. For example, the first operating condition may be a start-up operating condition or an idle operating condition of the engine. By contrast, the second operating condition may be a flight operating condition of the engine.

With such an exemplary aspect, it will be appreciated that providing electrical power from the electric machine to the engine controller at (404) includes at (414) providing a substantially constant amount of electric power from the electric machine to the engine controller when the engine is operated in the first operating condition at (410) and when the engine is operated in the second operating condition at (412). By contrast, however, with such exemplary aspect, it will be appreciated that providing electrical power from the electric machine to the fuel oxygen reduction unit at (406) includes at (416) providing a first amount of electrical power to the fuel oxygen reduction unit when the engine is operating in the first operating condition at (410) and providing a second amount of electrical power when the engine is operating in the second operating condition at (412). The first amount of electrical power is different than the second amount of electrical power. More specifically, the second amount of electric power is greater than the first amount of electrical power. For example, the second amount of electric power may be at least about 25% greater than the first amount of electric power, such as at least about 50% greater than the first amount of electric power, such as at least about 100% greater than the first amount of electric power, such as up to about 10000% greater than the first amount of electric power

In such manner, it will be appreciated that the engine controller is configured to receive a substantially constant amount of electric power across substantially all operating conditions of the engine, whereas the fuel oxygen reduction unit may be configured to receive a varying amount of electrical power based on, e.g., the operating condition of the engine.

Referring still to the method 400 of FIG. 4, the method further includes at (418) reducing an oxygen content of a fuel flow with the oxygen reduction unit using at least in part electrical power received from the electric machine. In at least certain exemplary aspects, the fuel oxygen reduction unit includes a gas boost pump. Accordingly, for the exemplary aspect shown, providing electrical power from the electric machine to the fuel oxygen reduction unit at (418) includes it (420) providing electrical power from the electric machine to an electric motor of the fuel oxygen reduction unit, the electric motor driving the gas boost pump.

It will further be appreciated that in at least certain exemplary aspects, the fuel oxygen reduction unit may additionally or alternatively include a fuel/gas separator. In such an exemplary aspect, providing electrical power from the electric machine to the fuel oxygen reduction unit at (418) may additionally, or alternatively, include providing electrical power from the electric machine to an electric motor of the fuel oxygen reduction unit, the electric motor driving the fuel/gas separator, the gas boost pump, or both.

It will further, still, be appreciated that the electric machine may be a dedicated electric machine for the fuel oxygen reduction unit and engine controller. In such a manner, it will be appreciated that for the exemplary aspect shown, providing electrical power from the electric machine to the fuel oxygen reduction unit at (406) includes at (422) providing substantially all of an amount of electrical power generated by the electric machine to the fuel oxygen reduction unit and the engine controller.

Notably, as will be appreciated from the discussion above, in certain exemplary aspects, the electric machine may be configured to generate an amount of electrical power in excess of that needed by the fuel oxygen reduction unit and engine controller for a given engine condition. Accordingly, in certain exemplary aspects providing electrical power from the electric machine to the fuel oxygen reduction unit at (406) may alternatively include at (424) providing substantially all of an amount of electrical power generated by the electric machine to the fuel oxygen reduction unit, the engine controller, and an electrical sink.

Moreover, it will be appreciated that in certain exemplary aspects, a method is provided for operating an engine system. The method may utilize one or more of the fuel oxygen reduction units, engine, and/or aircraft discussed herein, or any other suitable fuel oxygen reduction units, engine, and/or vehicle. The method generally includes reducing an oxygen content of a fuel flow to an engine of the engine system using a fuel oxygen reduction unit. Such a step may include or more of the steps described above with respect to the method 400, and may use one or more of the embodiments discussed above with reference to FIGS. 1 through 3.

In certain exemplary aspects, reducing the engine content of the fuel flow to the engine of the engine system using the fuel oxygen reduction unit includes consuming a total amount of power with the fuel oxygen reduction unit in British Thermal Units (“BTU”) per minute. Notably, it will also be appreciated that the fuel flow being treated by the fuel oxygen reduction unit and provided to, e.g., a combustion section of an engine, defines a power as well. The power of the fuel flow being treated may be calculated by converting the fuel flow to the combustion section from pounds per hour to BTU per minute.

With the configurations of the present disclosure, the power provided to the fuel oxygen reduction unit may be arranged to provide a desired oxygen level in the fuel flow being treated and provided to the combustion section, accounting for the amount of fuel being treated and provided to the combustion section. In particular, the inventors of the present disclosure have found a ratio of power used by the fuel oxygen reduction unit to power of the fuel flow treated by the fuel oxygen reduction unit and provided to the combustion section that provides for a desired amount of energy to the engine and reduces risk of damage from coking to a desired level.

In particular the ratio of the total amount of power used by the fuel oxygen reduction unit in BTU/minute to the power within the fuel flow in BTU/minute is between 0.0002:1 and 0.002:1. For example, the ratio may be at least 0.0004:1, at least 0.0006:1, or at least 0.0008:1, and less than or equal to 0.0016:1, less than or equal to 0.0014:1, less than or equal to 0.0012:1, or less than or equal to 0.001:1.

Moreover, it will be appreciated that in one or more of these exemplary aspects, the ratio of power used by the fuel oxygen reduction unit to power of the fuel flow treated by the fuel oxygen reduction unit and provided to the combustion section may be varied with an operating condition of the engine. For example, certain methods of the present disclosure may include operating the engine in a first operating mode at a first power level and operating the engine in a second operating mode at a second power level. The first power level may be higher than the second power level. For example, the first operating condition may be a takeoff operating condition or a climb operating condition, and the second operating condition may be a cruise operating condition, a descent operating condition, a loiter operating condition, or a ground idle operating condition. Additionally, or alternatively, the first operating condition may be flight operating condition and the second operating condition may be a ground operating condition (e.g., taxi, ground idle, shutdown, etc.).

In at least certain exemplary aspects the ratio may be lower in the first operating mode and higher in the second operating mode. For example, the ratio may be at least 5% higher when the engine is operated at the second operating mode, such as at least 10% higher, such as at least 15% higher, such as up to 100% higher.

In such a manner, it will be appreciated that such a method may be configured to provide more resources to the fuel oxygen reduction unit at relatively low power operation modes relative to at high power operation modes. Such may help reduce coking or other undesirable results when the engine is operated at low power operation modes (e.g., where the fuel flow through fuel nozzles of the combustion section relatively low and may be more susceptible to coking).

Further, operating an engine system in accordance with one or more of these methods, and when utilizing one or more of the exemplary engine system described above, such as the engine system of FIG. 3, the power ratios described may allow for the PMA to be capable of powering the fuel oxygen reduction unit (at least a portion or all) during the desired operating periods, while also providing the desired amount of power to the engine controller (e.g., the FADEC). For example, the engine controller may consume a substantially constant amount of power, e.g., around 1 kilowatt (kW), through most all engine operating modes, whereas a fuel oxygen reduction unit may consume somewhere between 1 kW and 100 kW depending on the engine configuration, engine operating mode, etc. The above ratio may facilitate such a power distribution from the PMA without requiring the PMA to be undesirably expanded in size.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

Further aspects of the invention are provided by the subject matter of the following clauses:

An engine system for an aircraft having an engine and an engine controller, the engine system comprising: an electric machine configured to be in electrical communication with the engine controller for powering the engine controller; and a fuel oxygen reduction unit defining a liquid fuel flowpath and a stripping gas flowpath and configured to transfer an oxygen content of a fuel flow through the liquid fuel flowpath to a stripping gas flow through the stripping gas flowpath, the fuel oxygen reduction unit also in electrical communication with the electric machine such that the electric machine powers at least in part the fuel oxygen reduction unit.

The engine system of one or more of these clauses, wherein the engine comprises an accessory gearbox, and wherein the electric machine is drivingly coupled to the accessory gearbox.

The engine system of one or more of these clauses, wherein the fuel oxygen reduction unit comprises a gas pump in airflow communication with the stripping gas flowpath, and wherein the gas pump is powered at least in part by the electric machine.

The engine system of one or more of these clauses, wherein the fuel oxygen reduction unit comprises a gas pump in airflow communication with the stripping gas flowpath, a contactor in fluid communication with the liquid fuel flowpath and the stripping gas flowpath for generating a fuel/gas mixture, and a separator for receiving the fuel/gas mixture from the contactor, wherein the gas pump, the separator, or both is powered at least in part by the electric machine.

The engine system of one or more of these clauses, wherein the electric machine is a permanent magnet alternator, and wherein the engine controller is a full authority digital engine control engine controller.

The engine system of one or more of these clauses, wherein the engine is a gas turbine engine.

The engine system of one or more of these clauses, further comprising: a power electronics assembly positioned electrically between the electric machine and the fuel oxygen reduction unit.

The engine system of one or more of these clauses, wherein the power electronics assembly includes an inverter, a rectifier, or both.

The engine system of one or more of these clauses, wherein the power electronics assembly includes a rectifier located proximate the electric machine and an inverter located proximate the fuel oxygen reduction unit.

The engine system of one or more of these clauses, wherein the electric machine is configured to provide substantially all of the electric power generated by the electric machine to the engine controller and the fuel oxygen reduction unit.

The engine system of one or more of these clauses, wherein the electric machine is configured to provide substantially all of the electric power generated by the electric machine to the engine controller, the fuel oxygen reduction unit, and an electrical sink.

A method for operating an engine system for an aircraft, the method comprising: providing electrical power from an electric machine to an engine controller; providing electrical power from the electric machine to a fuel oxygen reduction unit; and reducing an oxygen content of a fuel flow with the fuel oxygen reduction unit using at least in part the electrical power received from the electric machine.

The method of one or more of these clauses, wherein providing electrical power from the electric machine to the fuel oxygen reduction unit comprises providing electrical power from the electric machine to the fuel oxygen reduction unit concurrently with providing electrical power from the electric machine to the engine controller.

The method of one or more of these clauses, further comprising: operating an engine of the aircraft in a first operating condition, wherein the engine controller is an engine controller for the engine; and operating the engine of the aircraft in a second operating condition different than the first operating condition; wherein providing electrical power from the electric machine to the engine controller comprises providing a substantially constant amount of electrical power from the electric machine to the engine controller when the engine is operated in the first and second operating conditions.

The method of one or more of these clauses, wherein providing electrical power from the electric machine to the fuel oxygen reduction unit comprises providing a first amount of electrical power to the fuel oxygen reduction unit when the engine is operating in the first operating condition, and providing a second amount of electrical power to the fuel oxygen reduction unit when the engine is operating in the second operating condition, the first amount of electrical power being different than the second amount of electrical power.

The method of one or more of these clauses, further comprising: driving the electric machine with an accessory gearbox of an engine of the aircraft.

The method of one or more of these clauses, wherein providing electrical power from the electric machine to the fuel oxygen reduction unit comprises providing electrical power from the electric machine to an electric motor, the electric motor driving a gas boost pump of a fuel oxygen reduction unit.

The method of one or more of these clauses, wherein the electric machine is a permanent magnet alternator, and wherein the engine controller is a full authority digital engine control engine controller.

The method of one or more of these clauses, wherein providing electrical power from the electric machine to the fuel oxygen reduction unit comprises providing substantially all of an amount of electrical power generated by the electric machine to the fuel oxygen reduction unit and the engine controller.

A method for operating an engine system comprising: reducing an oxygen content of a fuel flow to an engine of the engine system using a fuel oxygen reduction unit, wherein reducing the engine content of the fuel flow to the engine of the engine system using the fuel oxygen reduction unit comprises consuming a total amount of power with the fuel oxygen reduction unit in BTU per minute; wherein a ratio of the total amount of power to a power within the fuel flow in BTU per minute is between 0.0002:1 and 0.002:1.

A method of one or more of these clauses, wherein the ratio is at least 0.0004:1, at least 0.0006:1, or at least 0.0008:1, and less than or equal to 0.0016:1, less than or equal to 0.0014:1, less than or equal to 0.0012:1, or less than or equal to 0.001:1

A method of one or more of these clauses, further comprising operating the engine in a first operating mode at a first power level and operating the engine in a second operating mode at a second power level, wherein the first power level is higher than the second power level.

A method of one or more of these clauses, wherein the first operating condition is a takeoff operating condition or a climb operating condition, and the second operating condition is a cruise operating condition, a descent operating condition, a loiter operating condition, or a ground idle operating condition.

A method of one or more of these clauses, wherein the first operating condition is a flight operating condition and the second operating condition is a ground operating condition (e.g., taxi, ground idle, shutdown, etc.).

A method of one or more of these clauses, wherein the ratio is lower in the first operating mode and higher in the second operating mode.

A method of one or more of these clauses, wherein the ratio is at least 5% higher when the engine is operated at the second operating mode, such as at least 10% higher, such as at least 15% higher, such as up to 100% higher.

A method of one or more of these clauses, utilizing or utilized with an engine system of one or more of these clauses.

A method of one or more of these clauses, wherein an outlet fuel provided by fuel oxygen reduction unit has an oxygen content of less than about twenty (20) parts per million (“ppm”), such as less than about fifteen (15) ppm, such as less than about ten (10) ppm, such as less than about five (5) ppm.

A method of one or more of these clauses, wherein the electric machine is adapted to operate in at least a first and second mode of operation providing a first amount of power and a second amount of power, respectively, where the second amount of electric power may be at least about 25% greater than the first amount of electric power, such as at least about 50% greater than the first amount of electric power, such as at least about 100% greater than the first amount of electric power, such as up to about 10000% greater than the first amount of electric power

An engine system of one or more of these clauses, utilizing or utilized with a method of one or more of these clauses.

What is claimed is:

1. An engine system for an aircraft having an engine and an engine controller, the engine system comprising:
an electric machine configured to be in electrical communication with the engine controller for powering the engine controller; and
a fuel oxygen reduction unit defining a liquid fuel flowpath and a stripping gas flowpath and configured to transfer an oxygen content of a fuel flow through the liquid fuel flowpath to a stripping gas flow through the stripping gas flowpath, the fuel oxygen reduction unit also in electrical communication with the electric machine such that the electric machine powers at least in part the fuel oxygen reduction unit.

2. The engine system of claim 1, wherein the engine comprises an accessory gearbox, and wherein the electric machine is drivingly coupled to the accessory gearbox.

3. The engine system of claim 1, wherein the fuel oxygen reduction unit comprises a gas pump in airflow communication with the stripping gas flowpath, and wherein the gas pump is powered at least in part by the electric machine.

4. The engine system of claim 1, wherein the fuel oxygen reduction unit comprises a gas pump in airflow communication with the stripping gas flowpath, a contactor in fluid communication with the liquid fuel flowpath and the stripping gas flowpath for generating a fuel/gas mixture, and a separator for receiving the fuel/gas mixture from the contactor, wherein the gas pump, the separator, or both is powered at least in part by the electric machine.

5. The engine system of claim 1, wherein the electric machine is a permanent magnet alternator, and wherein the engine controller is a full authority digital engine control engine controller.

6. The engine system of claim 1, wherein the engine is a gas turbine engine.

7. The engine system of claim 1, further comprising:
a power electronics assembly positioned electrically between the electric machine and the fuel oxygen reduction unit.

8. The engine system of claim 7, wherein the power electronics assembly includes an inverter, a rectifier, or both.

9. The engine system of claim 7, wherein the power electronics assembly includes a rectifier located proximate the electric machine and an inverter located proximate the fuel oxygen reduction unit.

10. The engine system of claim 1, wherein the electric machine is configured to provide substantially all of the electric power generated by the electric machine to the engine controller and the fuel oxygen reduction unit.

11. The engine system of claim 1, wherein the electric machine is configured to provide substantially all of the electric power generated by the electric machine to the engine controller, the fuel oxygen reduction unit, and an electrical sink

12. A method for operating an engine system for an aircraft, the method comprising:
providing electrical power from an electric machine to an engine controller;
providing electrical power from the electric machine to a fuel oxygen reduction unit; and
reducing an oxygen content of a fuel flow with the fuel oxygen reduction unit using at least in part the electrical power received from the electric machine.

13. The method of claim 12, wherein providing electrical power from the electric machine to the fuel oxygen reduction unit comprises providing electrical power from the electric machine to the fuel oxygen reduction unit concurrently with providing electrical power from the electric machine to the engine controller.

14. The method of claim 12, further comprising:
operating an engine of the aircraft in a first operating condition, wherein the engine controller is an engine controller for the engine; and
operating the engine of the aircraft in a second operating condition different than the first operating condition;
wherein providing electrical power from the electric machine to the engine controller comprises providing a substantially constant amount of electrical power from the electric machine to the engine controller when the engine is operated in the first and second operating conditions.

15. The method of claim 14, wherein providing electrical power from the electric machine to the fuel oxygen reduction unit comprises providing a first amount of electrical power to the fuel oxygen reduction unit when the engine is operating in the first operating condition, and providing a second amount of electrical power to the fuel oxygen reduction unit when the engine is operating in the second operating condition, the first amount of electrical power being different than the second amount of electrical power.

16. The method of claim 12, further comprising:
driving the electric machine with an accessory gearbox of an engine of the aircraft.

17. The method of claim 12, wherein providing electrical power from the electric machine to the fuel oxygen reduction unit comprises providing electrical power from the electric machine to an electric motor, the electric motor driving a gas boost pump of a fuel oxygen reduction unit.

18. The method of claim 12, wherein the electric machine is a permanent magnet alternator, and wherein the engine controller is a full authority digital engine control engine controller.

19. The method of claim 12, wherein providing electrical power from the electric machine to the fuel oxygen reduction unit comprises providing substantially all of an amount of electrical power generated by the electric machine to the fuel oxygen reduction unit and the engine controller.

20. A method for operating an engine system comprising:
reducing an oxygen content of a fuel flow to an engine of the engine system using a fuel oxygen reduction unit, wherein reducing the engine content of the fuel flow to the engine of the engine system using the fuel oxygen reduction unit comprises consuming a total amount of power with the fuel oxygen reduction unit in BTU per minute;
wherein the fuel flow defines a power in BTU per minute, and wherein a ratio of the total amount of power to the power within the fuel flow is between 0.0002:1 and 0.002:1.
